(19) United States
(12) Patent Application Publication
(10) Pub. No.: US 2026/0070380 A1
(43) Pub. Date: Mar. 12, 2026

(54) JOINT STRUCTURE OF VEHICLE

(71) Applicants: HYUNDAI MOTOR COMPANY, SEOUL (KR); KIA CORPORATION, SEOUL (KR)

(72) Inventor: Suin Park, Hwaseong-si (KR)

(73) Assignees: HYUNDAI MOTOR COMPANY, SEOUL (KR); KIA CORPORATION, SEOUL (KR)

(21) Appl. No.: 19/233,562

(22) Filed: Jun. 10, 2025

(30) Foreign Application Priority Data
Sep. 11, 2024 (KR) 10-2024-0123921

(51) Int. Cl. B60D 1/24; B60D 1/06; B60D 1/28; B60D 1/62

(52) U.S. Cl. CPC B60D 1/246; B60D 1/06; B60D 1/28; B60D 1/62

(57) ABSTRACT

A joint structure for a vehicle includes a drive module and a cargo module connected to the drive module and configured to move by power of the drive module are coupled, and includes a drive coupler provided at a rear portion of the drive module and connected to a front portion of the cargo module, and a cargo coupler provided at a front portion of the cargo module and connected to the drive coupler, in which the drive coupler is configured to operate to be coupled to or uncoupled from the cargo coupler by power of a fastening drive unit.

### CROSS REFERENCE TO RELATED APPLICATIONS

This application claims priority to and the benefit of Korean Patent Application No. 10-2024-0123921 filed with the Korean Intellectual Property Office on September 11, 2024, the entire contents of which are incorporated herein by reference.

### BACKGROUND

### (a) Field

The present disclosure relates to a joint structure for a vehicle, and more specifically, to a joint structure for a vehicle including a drive module and a cargo module connected to the drive module by a ball structure to which an electromagnetic force is applied.

### (b) Description of the Related Art

In general, a tractor (drive module) is a vehicle that tows a trailer (cargo module). The tractor is a front part of a large vehicle with driving capabilities that can mainly pull loads, and functions as a drive module, while the trailer is a rear part of the vehicle that carries loads, and functions as a cargo module.

A coupler is provided for connecting the tractor and the trailer. As shown in FIG. 1, a tractor 1 and trailer 2 are physically fastened through a coupler 3. As shown in FIG. 2, the coupler 3 is formed by coupling of a tractor-side coupler 3-1 and a trailer-side coupler 3-2. When the tractor 1 suddenly decelerates or brakes in a constant-speed state (a), the front side of the tractor-side coupler 3-1 collides with the trailer-side coupler 3-2 and an impact is applied (b), and when the tractor 1 rapidly accelerates in a stopped state or constant-speed state, the rear side of the tractor-side coupler 3-1 collides with the trailer-side coupler 3-2 and an impact is applied (c). This is because a play is formed between the tractor side coupler 3-1 and the trailer side coupler 3-2.

In this way, in situations where the tractor 1 accelerates or decelerates or is traveling on a sloped road, an impact or slipping phenomenon may occur between the tractor 1 and the trailer 2, causing traveling instability. Additionally, this has an adverse effect on ride comfort and poses a risk of the tractor 1 and trailer 2 becoming detached. Therefore, it is desirable to develop a joint structure for a vehicle to prevent an impact or slipping phenomenon from occurring between the tractor-side coupler 3-1 and the trailer-side coupler 3-2.

### SUMMARY

Therefore, an embodiment of the present disclosure attempts to provide a joint structure for a vehicle capable of preventing collisions in front-rear and upper-lower directions during fastening of a drive module and a cargo module, and ensuring ride comfort for a passenger aboard the drive module by adopting a ball structure to which an electromagnetic force is applied is adopted in a coupler joint structure for connecting the drive module and the cargo module.

A joint structure for a vehicle according to an embodiment of the present disclosure is a joint structure for a vehicle in which a drive module and a cargo module connected to the drive module and configured to move by power of the drive module are coupled, and includes a drive coupler provided at a rear portion of the drive module and connected to a front portion of the cargo module, and a cargo coupler provided at a front portion of the cargo module and connected to the drive coupler, in which the drive coupler is configured to operate to be coupled to or uncoupled from the cargo coupler by power of a fastening drive unit.

The drive coupler may include an upper drive coupler configured to operate to move up and down on an upper portion of the cargo coupler to cover or uncover the upper portion of the cargo coupler, and a lower drive coupler configured to operate to move up and down on a lower portion of the cargo coupler to cover or uncover the lower portion of the cargo coupler.

The cargo coupler may include a cargo coupler body portion connected to a front portion of the cargo module, and a cargo coupler head portion having a spherical shape and rotatably coupled to an end portion of the cargo coupler body portion.

The fastening drive unit may include a motor and a toothed gear configured to rotate by a drive force of the motor, and the upper drive coupler and the lower drive coupler may be configured to move up and down by rotation of the toothed gear.

The upper drive coupler and the lower drive coupler may each include a drive coupler body portion connected to a rear portion of the drive module and a drive coupler head portion fixedly connected to an end portion of the drive coupler body portion.

The drive coupler head portion may take a hemispherical shape so as to be coupled to the cargo coupler head portion while surrounding it and forming a gap.

The drive coupler body portions of the upper drive coupler and the lower drive coupler may be provided with an upper linear gear and a lower linear gear arranged to face each other, respectively, a tooth gear may be connected with the upper linear gear and the lower linear gear at the same time, and the upper drive coupler and the lower drive coupler may be configured to move closer to or further away from each other during rotation of the toothed gear.

The cargo coupler head portion may have one polarity, and the drive coupler head portion may have a variable polarity to maintain a gap with the cargo coupler head portion.

A plurality of electromagnets may be provided on an inner portion of the drive coupler head portion, and polarities of the plurality of electromagnets may be changed by control of a switching circuit.

In a stationary state or a constant-speed state of the vehicle, the inner portion of the drive coupler head portion may be maintained to form the same electromagnetic force intensity with a polarity opposite to that of the cargo coupler head portion.

In a rapid acceleration state of the vehicle, the inner portion of the drive coupler head portion may change to form the same polarity as that of the cargo coupler head portion on the cargo module side and to form a greater electromagnetic force intensity with a polarity opposite to that of the cargo coupler head portion on the drive module side.

In a rapid deceleration state of the vehicle, the inner portion of the drive coupler head portion may change to form the same polarity as that of the cargo coupler head portion on the drive module side and to form a greater electromagnetic force intensity with a polarity opposite to that of the cargo coupler head portion on the cargo module side.

In a turning state of the vehicle, the inner portion of the drive coupler head portion may change to form the same polarity as that of the cargo coupler head portion on a side where a centrifugal force acts, and to form a greater electromagnetic force intensity with a polarity opposite to that of the cargo coupler head portion on a side where a centripetal force acts.

In a disconnected state of the drive coupler and cargo coupler, the inner portion of the drive coupler head portion may be maintained to form the same electromagnetic force intensity with the same polarity as that of the cargo coupler head portion.

In a state where the vehicle is traveling on a sloped surface, the drive coupler body portion and the cargo coupler body portion may change to form the same angle as the sloped surface while being coupled.

In a state where the vehicle is traveling on a sloped surface, the drive coupler head portion may rotate by such an angle that an end portion thereof engages with a boundary portion between the cargo coupler head portion and the cargo coupler body portion.

The angle may be between 13° and 15°.

The cargo coupler head portion may be coupled to rotate within a range of 5° in an upper-lower direction at the boundary portion with the cargo coupler body portion.

A stopper may be provided below the toothed gear to stop rotation of the toothed gear so as to maintain a coupled state of the drive coupler and the cargo coupler.

The stopper may include a ratchet engaged with the toothed gear to stop rotation of the toothed gear, an actuator connected to the ratchet and configured to be actuated to linearly move the ratchet when power is supplied, and a spring interposed between the ratchet and the actuator and having elasticity to move the ratchet toward the toothed gear when power is not supplied to the actuator.

According to an embodiment of the present disclosure, in a joint structure for a vehicle including a tractor (drive module) and a trailer (cargo module) coupled to a rear end of the tractor, the adoption of a coupler with a ball structure to which an electromagnetic force is applied enables smooth direction changes during turning and during traveling on a sloped surface, thereby improving traveling stability.

In addition, since the electromagnetic force applied to the coupler is automatically controlled in situations of rapid acceleration and rapid deceleration of the vehicle, collision between the two modules in the coupler connection structure can be prevented, thereby improving riding comfort.

Further, in addition to the joint structure between the tractor and the trailer, the joint structure for a vehicle can also be widely adopted in the fastening method of Purpose Built Vehicle (PBV) including a drive module and a space module for passengers, and can be applied from a manual method to an automatic method, thereby improving marketability.

### BRIEF DESCRIPTION OF THE FIGURES

FIG. 1 is a view showing a connected state of a vehicle in which a tractor and a trailer are fastened via a coupler of the related art.

FIGS. 2A, 2B, and FIG. 2C are a views showing states of the coupler during rapid deceleration and rapid acceleration in the connected state in which the tractor and the trailer are fastened via the coupler of the related art.

FIG. 3 is a view showing a state before fastening of a coupler in a joint structure for a vehicle according to an embodiment of the present disclosure.

FIG. 4 is a view showing a state in which the coupler is being fastened in the joint structure for a vehicle according to an embodiment of the present disclosure.

FIG. 5 is a view showing a state after fastening of the coupler in the joint structure for a vehicle according to an embodiment of the present disclosure.

FIG. 6 is a view showing an electromagnet provided in a drive coupler in the joint structure for a vehicle according to an embodiment of the present disclosure.

FIG. 7 is a diagram showing an electronic circuit for changing a polarity of the electromagnet of FIG. 6.

FIGS. 8A and 8B are a views showing a coupled state of a drive coupler and a cargo coupler in a stationary state or constant-speed state of a vehicle, in the joint structure for a vehicle according to an embodiment of the present disclosure.

FIGS. 9A and 9B are views showing a coupled state of the drive coupler and the cargo coupler during rapid acceleration of a vehicle, in the joint structure for a vehicle according to an embodiment of the present disclosure.

FIGS. 10A and 10B are views showing a coupled state of the drive coupler and the cargo coupler during rapid deceleration of a vehicle, in the joint structure for a vehicle according to an embodiment of the present disclosure.

FIGS. 11A and 11B are views showing a coupled state of the drive coupler and the cargo coupler during a left turn of a vehicle, in the joint structure for a vehicle according to an embodiment of the present disclosure.

FIGS. 12A and 12B are views showing a coupled state of the drive coupler and the cargo coupler during a right turn of a vehicle, in the joint structure for a vehicle according to an embodiment of the present disclosure.

FIGS. 13A and 13B are views showing an uncoupled state of the drive coupler and the cargo coupler, in the joint structure for a vehicle according to an embodiment of the present disclosure.

FIG. 14 is a view showing a coupled state of the coupler while a vehicle is traveling on a sloped surface inclined to the right, in the joint structure for a vehicle according to an embodiment of the present disclosure.

FIG. 15 is a view showing a state in which a toothed gear is rotatable to allow the drive coupler and the cargo coupler to be coupled or separated, in the joint structure for a vehicle according to an embodiment of the present disclosure.

FIG. 16 is a view showing a state in which the toothed gear is fixed in rotation to maintain the coupled state of the drive coupler and the cargo coupler, in the joint structure for a vehicle according to an embodiment of the present disclosure.

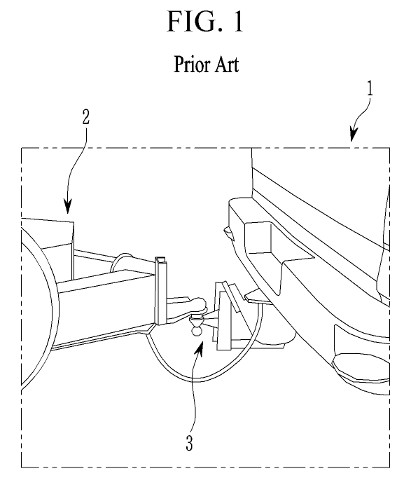

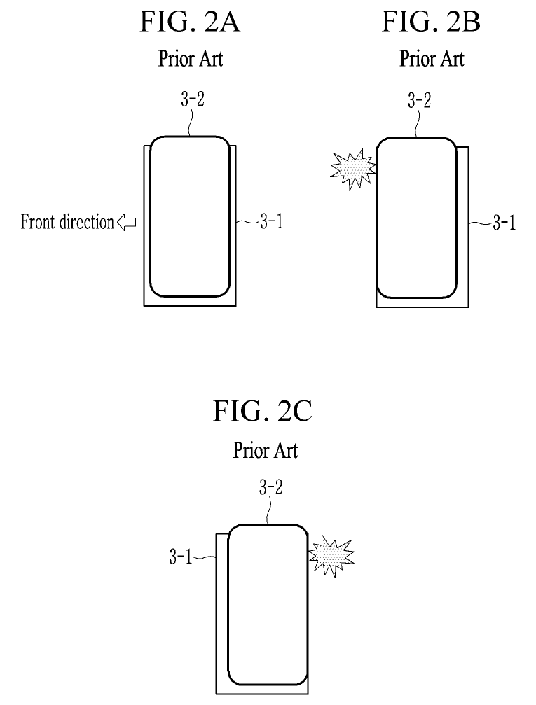

### DETAILED DESCRIPTION

In the following detailed description, only certain embodiments of the present disclosure have been shown and described, simply by way of illustration. The present disclosure can be variously implemented and is not limited to the following embodiments.

Further, in various embodiments, since like reference numerals designate like elements having the same configuration, a first embodiment will be representatively described, and in other embodiments, only configurations different from the first embodiment will be described.

It should be noted that the drawings are schematic and not drawn to scale. The relative dimensions and ratios of the parts in the drawings are shown exaggerated or reduced in size for clarity and convenience in the drawings, and any dimension is merely exemplary and not limiting. In addition, the same reference numerals are used to denote similar features in the same structures, elements, or parts shown in two or more drawings. When a part is referred to as being "above" or "on" another part, it may be directly above or on the other part or an intervening part may also be present.

The embodiment of the present disclosure specifically shows an embodiment of the present disclosure. As a result, various modifications of the drawings will be expected. Therefore, the embodiment is not limited to a specific aspect of an illustrated region, and for example, includes modifications of an aspect by manufacturing.

Hereinafter, a joint structure for a vehicle according to an embodiment of the present disclosure will be described in detail with reference to the accompanying drawings.

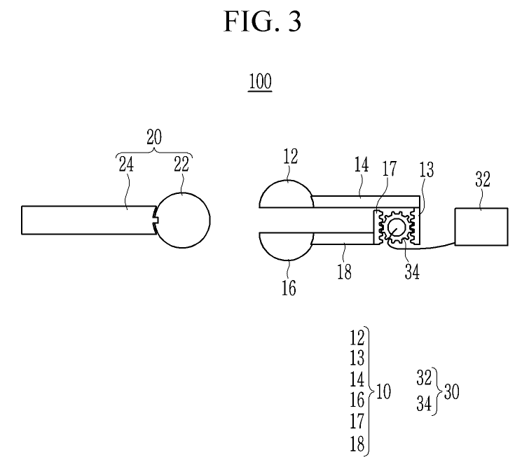

FIG. 3 is a view showing a state before fastening of a coupler in a joint structure for a vehicle according to an embodiment of the present disclosure.

Referring to FIG. 3, a joint structure for a vehicle 100 according to an embodiment of the present disclosure is a structure in which a drive module (not shown) and a cargo module (not shown) connected thereto and configured to move by power of the drive module are coupled, and includes a drive coupler 10 and a cargo coupler 20. Here, the drive module may be a tractor that provides power, and the cargo module may be a trailer that is connected to the tractor and can be loaded with cargo and the like.

The drive coupler 10 is provided at a rear portion of the drive module and may be connected to a front portion of the cargo module, while the cargo coupler 20 is provided at a front portion of the cargo module and may be connected to the drive coupler 10. The drive coupler 10 is provided with a fastening drive unit 30 and may be actuated to be coupled to or uncoupled from the cargo coupler 20 by power of the fastening drive unit 30.

The drive coupler 10 may include an upper drive coupler 12 and 14 and a lower drive coupler 16 and 18. The upper drive coupler 12 and 14 and the lower drive coupler 16 and 18 may be vertically connected in a symmetrical manner to each other, and may each include a drive coupler body portion 14, 18 and a drive coupler head portion 12, 16. The drive coupler body portions 14 and 18 are connected to a rear portion of the drive module and may each be formed as a straight bar. Additionally, the drive coupler head portions 12 and 16 may be fixedly coupled to end portions of the drive coupler body portions 14 and 18, respectively.

The cargo coupler 20 may include a cargo coupler body portion 24 and a cargo coupler head portion 22. The cargo coupler body portion 24 is connected to a front portion of the cargo module and may be formed as a straight bar. Additionally, the cargo coupler head portion 22 may be coupled to an end portion of the cargo coupler body portion 24 so as to be rotatable within a predetermined range. The cargo coupler head portion 22 may be formed as a sphere. Accordingly, the drive coupler head portions 12 and 16 may have a hemispherical shape so as to be coupled to the cargo coupler head portion 22 while surrounding the cargo coupler head portion, and forming a gap.

The fastening drive unit 30 includes a motor 32 and a toothed gear 34 that rotates by a drive force of the motor 32, and the upper drive coupler 12 and 14 and the lower drive coupler 16 and 18 can move up and down by rotation of the toothed gear 34.

The drive coupler body portions 14 and 18 of the upper drive coupler 12 and 14 and the lower drive coupler 16 and 18 may be provided with an upper linear gear 13 and a lower linear gear 17 arranged to face each other, respectively.

The upper linear gear 13 and the lower linear gear 17 may extend in a direction perpendicular to a length direction of the drive coupler body portions 14 and 18. The drive coupler body portion 18 of the lower drive coupler 16 and 18 may be shorter than the drive coupler body portion 14 of the upper drive coupler 12 and 14, so that the upper linear gear 13 and the lower linear gear 17 form a gap therebetween while facing each other. A toothed gear 34 may be arranged in the gap. The toothed gear 34 may be interconnected with the upper linear gear 13 and the lower linear gear 17 at the same time.

When the toothed gear 34 rotates by the drive force of the motor 32, the upper linear gear 13 and the lower linear gear 17 move in opposite directions, thereby allowing the upper drive coupler 12 and 14 and the lower drive coupler 16 and 18 to move closer to or further away from each other.

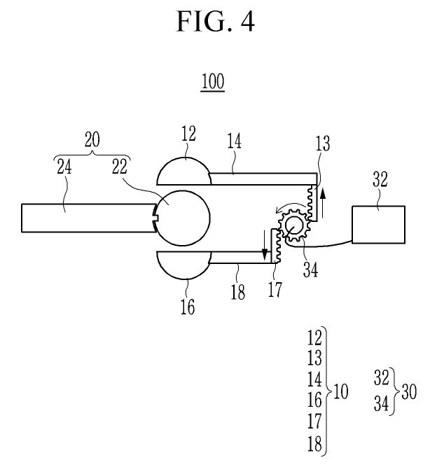

FIG. 4 is a view showing a state in which the coupler is being fastened in the joint structure for a vehicle according to an embodiment of the present disclosure.

Referring to FIG. 4, the drive module and the cargo module are moved closer to each other to be coupled, the upper drive coupler 12 and 14 and the lower drive coupler 16 and 18 are moved away from each other in the upper-lower direction, and in this state, the cargo coupler 20 is arranged therebetween. In a state in which the drive coupler head portion 12 of the upper drive coupler 12 and 14 and the drive coupler head portion 16 of the lower drive coupler 16 and 18 face each other, the cargo coupler head portion 22 is arranged therebetween.

The toothed gear 34 is rotated counterclockwise by the drive force of the motor 32, so that the linear gears 13 and 17 interconnected with the toothed gear 34 move away from each other in the upper-lower direction, thereby causing the upper drive couplers 12 and 14 and the lower drive couplers 16 and 18 to move away from each other.

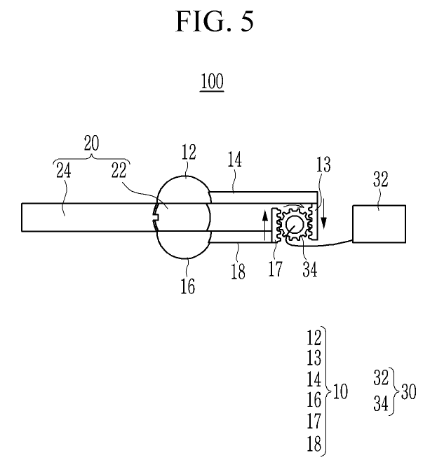

FIG. 5 is a view showing a state after fastening of the coupler in the joint structure for a vehicle according to an embodiment of the present disclosure.

Referring to FIG. 5, the toothed gear 34 is rotated clockwise by the drive force of the motor 32, so that the linear gears 13 and 17 interconnected with the toothed gear 34 move closer to each other in the upper-lower direction, thereby bringing the upper drive coupler 12 and 14 and the lower drive coupler 16 and 18 closer to each other. In this state, the drive coupler 10 and the cargo coupler 20 are coupled in a form where the drive coupler head portions 12 and 16 surround the cargo coupler head portion 22. In this case, the upper drive coupler 12 and 14 and the lower drive coupler 16 and 18 form a predetermined gap with each other and can rotate in the upper-lower direction in a form where the drive coupler head portions 12 and 16 surround the cargo coupler head portion 22.

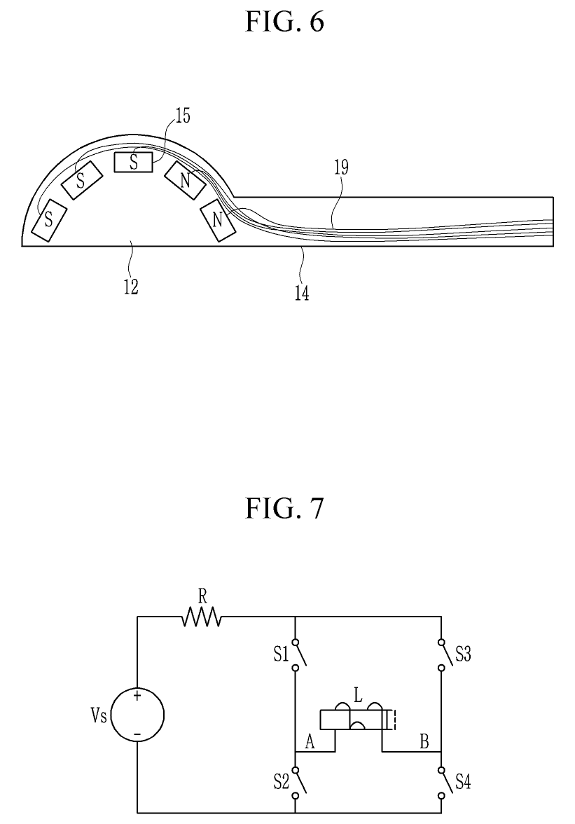

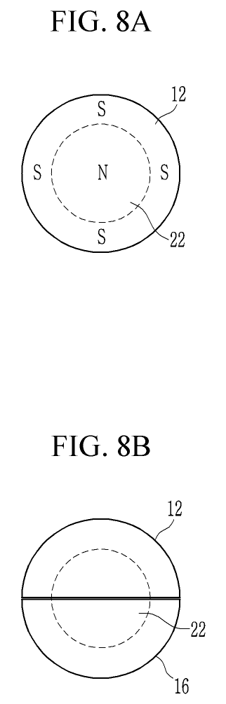

FIG. 6 is a view showing an electromagnet provided in the drive coupler in the joint structure for a vehicle according to an embodiment of the present disclosure, FIG. 7 is a diagram showing an electronic circuit for changing a polarity of the electromagnet of FIG. 6, and FIG. 8 is a view showing a coupled state of the drive coupler and the cargo coupler in a stationary state or constant-speed state of a vehicle, in the joint structure for a vehicle according to an embodiment of the present disclosure.

First, referring to FIG. 8, the cargo coupler head portion 22 has one polarity, while the drive coupler head portions 12 and 16 have varying polarities and may operate to maintain a gap with the cargo coupler head portion 22.

In the present specification, an example will be described in which the cargo coupler head portion 22 has an 'N' polarity. As shown in FIG. 8, in the coupled state of the drive coupler 10 and the cargo coupler 20, the cargo coupler head portion 22 has an 'N' polarity and the drive coupler head portions 12 and 16 have an 'S' polarity throughout their entirety, so that the drive coupler head portions 12 and 16 can maintain a balanced gap with the cargo coupler head portion 22.

As shown in FIG. 6, a plurality of electromagnets 15 may be provided on inner portions of the drive coupler head portions 12 and 16, and the polarities of the plurality of electromagnets 15 may be changed by the switching circuit. An electric wire 19 may be connected to and wound around each of the plurality of electromagnets 15, and the polarity of each electromagnet 15 may be changed depending on a direction of flow of current passing through the wire 19.

Referring to FIG. 7, when switches S1 and S4 close, current flows in a direction from A to B through an electromagnet L. In addition, when switches S2 and S3 close, current flows in a direction from B to A through the electromagnet L. The electromagnet L may be formed as a single-polarity electromagnet, and the polarity of the electromagnet L may be determined depending on the direction of the current flowing through the electromagnet L.

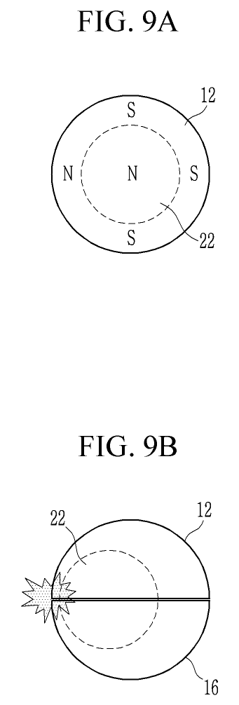

FIG. 9 is a view showing a coupled state of the drive coupler and the cargo coupler during rapid acceleration of a vehicle, in the joint structure for a vehicle according to an embodiment of the present disclosure. FIGS. 9A, 10A, 11A, 12A, and FIG. 13A are top views showing the coupled state of the drive coupler 10 and the cargo coupler 20, and FIGS. 9B, 10B, 11B, 12B, and FIG. 13B are side views showing the coupled state of the drive coupler 10 and the cargo coupler 20. Additionally, in FIGS. 9 to 13, the right side represents the front of the vehicle, and the left side represents the rear of the vehicle.

As shown in FIG. 9B, when the vehicle is rapidly accelerated, the cargo coupler head portion 22 collides with the left inner side of the drive coupler head portions 12 and 16 due to inertia, which adversely affects ride quality and may cause damage and separation of the drive module and the cargo module.

Therefore, as shown in FIG. 9A, in an embodiment of the present disclosure, the cargo coupler head portion 22 is formed to have an 'N' polarity, and the electromagnet 15 on the left inner side of the drive coupler head portions 12 and 16, which is located at a position where there is a risk of impact during rapid acceleration, is controlled to form an 'N' polarity so that a repulsive force is exerted. In addition, the electromagnet 15 on the opposite inner side the drive coupler head portions 12 and 16 is controlled to generate a strong 'S' polarity so that an attractive force is exerted. This can make it possible for the cargo coupler head portion 22 to maintain a constant gap with the drive coupler head portions 12 and 16 in all directions.

When the cargo coupler head portion 22 is formed to have an 'S' polarity, the polarities generated in the electromagnets 15 on the inner side of the drive coupler head portions 12 and 16 may be opposite to the polarities described above.

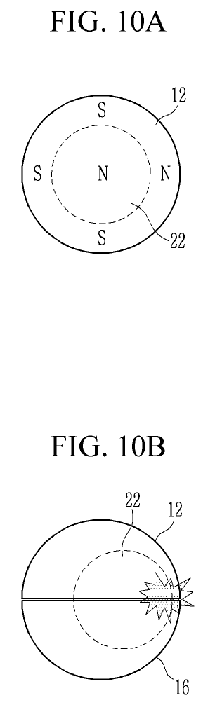

FIG. 10 is a view showing a coupled state of the drive coupler and the cargo coupler during rapid deceleration of a vehicle, in the joint structure for a vehicle according to an embodiment of the present disclosure.

As shown in FIG. 10B, when the vehicle is rapidly decelerated, the cargo coupler head portion 22 collides with the right inner side of the drive coupler head portions 12 and 16 due to inertia. Therefore, as shown in FIG. 10A, in an embodiment of the present disclosure, the cargo coupler head portion 22 is formed to have an 'N' polarity, and the electromagnet 15 on the right inner side of the drive coupler head portions 12 and 16, which is located at a position where there is a risk of impact during rapid deceleration, is controlled to form an 'N' polarity so that a repulsive force is exerted. In addition, the electromagnet 15 on the opposite inner side the drive coupler head portions 12 and 16 is controlled to generate a strong 'S' polarity so that an attractive force is exerted. This can make it possible for the cargo coupler head portion 22 to maintain a constant gap with the drive coupler head portions 12 and 16 in all directions.

Likewise, when the cargo coupler head portion 22 is formed to have an 'S' polarity, the polarities generated in the electromagnets 15 on the inner side of the drive coupler head portions 12 and 16 may be opposite to the polarities described above.

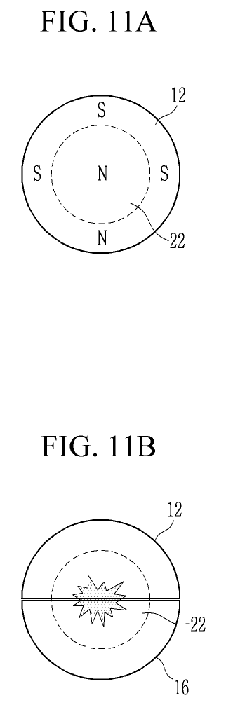

FIG. 11 is a view showing a coupled state of the drive coupler and the cargo coupler during a left turn of a vehicle, in the joint structure for a vehicle according to an embodiment of the present disclosure.

As shown in FIG. 11B, when the vehicle turns to the left, the cargo coupler head portion 22 collides with the central front inner side of the drive coupler head portions 12 and 16 due to inertia. Therefore, as shown in FIG. 11A, in an embodiment of the present disclosure, the cargo coupler head portion 22 is formed to have an 'N' polarity, and the electromagnet 15 on the lower inner side of the drive coupler head portions 12 and 16, which is located at a position where there is a risk of impact during turning, is controlled to form an 'N' polarity so that a repulsive force is exerted. In addition, the electromagnet 15 on the opposite inner side the drive coupler head portions 12 and 16 is controlled to generate a strong 'S' polarity so that an attractive force is exerted. This can make it possible for the cargo coupler head portion 22 to maintain a constant gap with the drive coupler head portions 12 and 16 in all directions.

Likewise, when the cargo coupler head portion 22 is formed to have an 'S' polarity, the polarities generated in the electromagnets 15 on the inner side of the drive coupler head portions 12 and 16 may be opposite to the polarities described above.

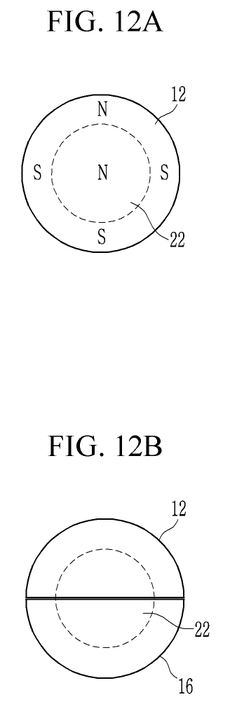

FIG. 12 is a view showing a coupled state of the drive coupler and the cargo coupler during a right turn of a vehicle, in the joint structure for a vehicle according to an embodiment of the present disclosure.

As shown in FIG. 12B, when the vehicle turns to the right, the cargo coupler head portion 22 collides with the central rear inner side of the drive coupler head portions 12 and 16 due to inertia. Therefore, as shown in FIG. 12A, in an embodiment of the present disclosure, the cargo coupler head portion 22 is formed to have an 'N' polarity, and the electromagnet 15 on the upper inner side of the drive coupler head portions 12 and 16, which is located at a position where there is a risk of impact during turning, is controlled to form an 'N' polarity so that a repulsive force is exerted. In addition, the electromagnet 15 on the opposite inner side the drive coupler head portions 12 and 16 is controlled to generate a strong 'S' polarity so that an attractive force is exerted. This can make it possible for the cargo coupler head portion 22 to maintain a constant gap with the drive coupler head portions 12 and 16 in all directions.

Likewise, when the cargo coupler head portion 22 is formed to have an 'S' polarity, the polarities generated in the electromagnets 15 on the inner side of the drive coupler head portions 12 and 16 may be opposite to the polarities described above.

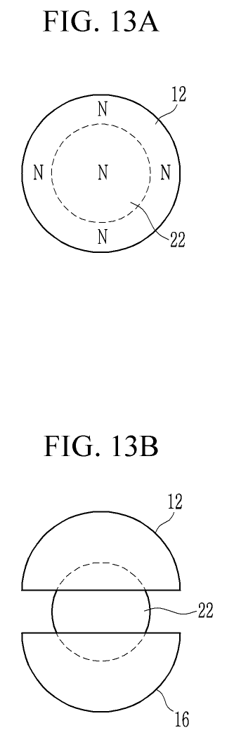

FIG. 13 is a view showing an uncoupled state of the drive coupler and the cargo coupler, in the joint structure for a vehicle according to an embodiment of the present disclosure.

As shown in FIG. 13, when the cargo coupler head portion 22 is formed to have an 'N' polarity in the stationary state of the vehicle, the electromagnet 15 on the entire inner side of the drive coupler head portions 12 and 16 is controlled to form an 'N' polarity so that a repulsive force is exerted. Then, the fastening drive unit 30 is caused to generate power, thereby uncoupling the drive coupler 10 and the cargo coupler 20.

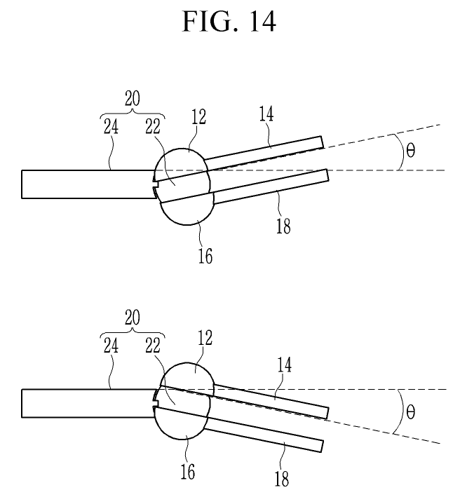

FIG. 14 is a view showing a coupled state of the coupler while a vehicle is traveling on a sloped surface inclined to the right, in the joint structure for a vehicle according to an embodiment of the present disclosure.

Referring to FIG. 14, the drive coupler head portions 12 and 16 are coupled to the cargo coupler head portion 22 while surrounding it and forming a gap. Additionally, the cargo coupler head portion 22 may be formed in a spherical shape, while the drive coupler head portions 12 and 16 may be formed in a hemispherical shape. Such a structure enables the drive coupler head portions 12 and 16 to rotate by a predetermined angle while surrounding the cargo coupler head portion 22. The drive coupler head portions 12 and 16 can rotate within a range of about 90° in each of the left and right directions of the vehicle, and can rotate in the upper-lower direction of the vehicle by an angle θ that is an angle at which an end portion of each of the drive coupler head portions 12 and 16 engages with a boundary portion between the cargo coupler head portion 22 and the cargo coupler body portion 24. In this case, the angle θ may be about 13° to about 15°.

The spherical cargo coupler head portion 22 may be coupled to an end portion of the cargo coupler body portion 24 so as to be rotatable by about 5°. Accordingly, the drive coupler head portions 12 and 16 may be provided to rotate within a range of about 17° to about 20° in the upper-lower direction of the vehicle.

In a state where the vehicle is traveling on a sloped surface, as the drive coupler head portions 12 and 16 and the cargo coupler head portion 22 rotate, the drive coupler body portions 14 and 18 and the cargo coupler body portion 24 can be changed to form the same angle as the sloped surface while being coupled.

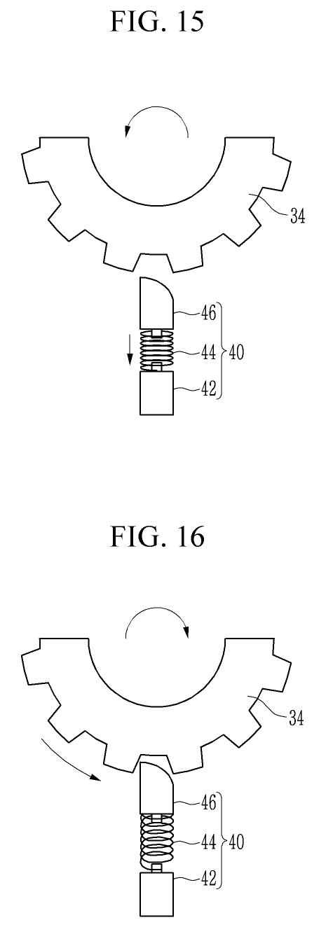

FIG. 15 is a view showing a state in which the toothed gear is rotatable to allow the drive coupler and the cargo coupler to be coupled or separated, in the joint structure for a vehicle according to an embodiment of the present disclosure, and FIG. 16 is a view showing a state in which the toothed gear is fixed in rotation to maintain the coupled state of the drive coupler and the cargo coupler, in the joint structure for a vehicle according to an embodiment of the present disclosure.

As shown in FIGS. 15 and 16, a stopper 40 may be provided below the toothed gear 34 to maintain the coupled state of the drive coupler 10 and the cargo coupler 20. The stopper 40 can stop the rotation of the toothed gear 34 in the coupled state of the drive coupler 10 and the cargo coupler 20.

The stopper 40 may include a ratchet 46, an actuator 42, and a spring 44. The ratchet 46 can be brought into direct contact with and engaged with the toothed gear 34 to stop the rotation of the toothed gear 34.

The actuator 42 is connected to a lower portion of the ratchet 46 and can be operated to linearly move the ratchet 46 up and down as power is supplied.

The spring 44 with elasticity may be interposed between the ratchet 46 and the actuator 42. The spring 44 can exert an elastic force in a direction in which the ratchet 46 is pushed toward the toothed gear 34 in a state where power is not supplied to the actuator 42.

As shown in FIG. 15, when power is supplied to the actuator 42, the actuator 42 pulls the ratchet 46 downward, so that the ratchet 46 is released from contact with the toothed gear 34, and the toothed gear 34 is put into a rotatable state. Additionally, the spring 44 is compressed between the ratchet 46 and the actuator 42.

As shown in FIG. 16, when a discharge or unstable power supply situation occurs in the vehicle in the coupled state of the drive coupler 10 and the cargo coupler 20, the ratchet 46 is automatically engaged with the toothed gear 34 by the elasticity of the spring 44 to stop the rotation of the toothed gear 34, and maintain the coupling of the drive coupler 10 and the cargo coupler 20, thereby preventing a dangerous situation in which the drive module and the cargo module are separated.

As such, according to an embodiment of the present disclosure, in a joint structure for a vehicle including a tractor (drive module) and a trailer (cargo module) coupled to a rear end of the tractor, the adoption of a coupler with a ball structure to which an electromagnetic force is applied enables smooth direction changes during turning and during traveling on a sloped surface, thereby improving traveling stability.

In addition, since the electromagnetic force applied to the coupler is automatically controlled in situations of rapid acceleration and rapid deceleration of the vehicle, collision between the two modules in the coupler connection structure can be prevented, thereby improving riding comfort.

Further, in addition to the joint structure between the tractor and the trailer, the joint structure for a vehicle can also be widely adopted in the fastening method of PBV vehicles including a drive module and a space module for passengers, and can be applied from a manual method to an automatic method, thereby improving marketability.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

1. A joint structure for a vehicle having a drive module and a cargo module connected to the drive module, the joint structure being configured to move by power of the drive module, the joint structure comprising:
a drive coupler positioned at a rear portion of the drive module and connected to a front portion of the cargo module; and
a cargo coupler positioned at a front portion of the cargo module and connected to the drive coupler;
wherein the drive coupler is configured be coupled to or uncoupled from the cargo coupler by power of a fastening drive unit.

2. The joint structure of a vehicle body of claim 1, wherein the drive coupler comprises:
an upper drive coupler configured to move up and down on an upper portion of the cargo coupler to cover or uncover the upper portion of the cargo coupler; and
a lower drive coupler configured to move up and down on a lower portion of the cargo coupler to cover or uncover the lower portion of the cargo coupler.

3. The joint structure of a vehicle body of claim 2, wherein the cargo coupler comprises:
a cargo coupler body portion connected to a front portion of the cargo module; and
a cargo coupler head portion having a spherical shape and rotatably coupled to an end portion of the cargo coupler body portion.

4. The joint structure of a vehicle body of claim 3, wherein the fastening drive unit comprises:
a motor; and
a toothed gear configured to rotate by a drive force of the motor;
wherein the upper drive coupler and the lower drive coupler are configured to move up and down by rotation of the toothed gear.

5. The joint structure of a vehicle body of claim 4, wherein the upper drive coupler and the lower drive coupler each comprise a drive coupler body portion connected to a rear portion of the drive module, and a drive coupler head portion fixedly connected to an end portion of the drive coupler body portion.

6. The joint structure of a vehicle body of claim 5, wherein each of the drive coupler head portions has a hemispherical shape so as to be coupled to the cargo coupler head portion while surrounding the cargo coupler head portion, and forming a gap.

7. The joint structure of a vehicle body of claim 6, wherein each of the drive coupler body portions of the upper drive coupler and the lower drive coupler include:
an upper linear gear positioned on the drive coupler body portion of the upper drive coupler and a lower linear gear positioned on the drive coupler body portion of the lower drive coupler, wherein the upper linear gear and the lower linear gear are arranged to face each other; and
a tooth gear interconnected with the upper linear gear and the lower linear gear at the same time;
wherein the upper drive coupler and the lower drive coupler are configured to move closer to or further away from each other during rotation of the toothed gear.

8. The joint structure of a vehicle body of claim 6, wherein the cargo coupler head portion has one polarity, and wherein each of the drive coupler head portions has a variable polarity to maintain the gap with the cargo coupler head portion.

9. The joint structure of a vehicle body of claim 8, wherein a plurality of electromagnets are positioned on an inner portion of each of the drive coupler head portions, and polarities of the plurality of electromagnets are configured to be changed by a switching circuit.

10. The joint structure of a vehicle body of claim 9, wherein, in a stationary state or a constant-speed state of the vehicle, the inner portion of each of the drive coupler head portions is configured to maintain at a same electromagnetic force intensity with a polarity opposite to the polarity of the cargo coupler head portion.

11. The joint structure of a vehicle body of claim 9, wherein, in a rapid acceleration state of the vehicle, the inner portion of each of the drive coupler head portions is configured to change to a same polarity as the polarity of the cargo coupler head portions on a cargo module side, and to form a greater electromagnetic force intensity with a polarity opposite to the polarity of the cargo coupler head portion on a drive module side.

12. The joint structure of a vehicle body of claim 9, wherein, in a rapid deceleration state of the vehicle, the inner portion of each of the drive coupler head portion is configured to change to a same polarity as the polarity of the cargo coupler head portion on a drive module side, and to form a greater electromagnetic force intensity with a polarity opposite to the polarity of the cargo coupler head portion on a cargo module side.

13. The joint structure of a vehicle body of claim 9, wherein, in a turning state of the vehicle, the inner portion of each of the drive coupler head portions is configured to change to a same polarity as the polarity of the cargo coupler head portion on a side where a centrifugal force acts, and to form a greater electromagnetic force intensity with a polarity opposite to the polarity of the cargo coupler head portion on the side where a centripetal force acts.

14. The joint structure of a vehicle body of claim 9, wherein, in a disconnected state of the drive coupler and cargo coupler, the inner portion of each of the drive coupler head portions is configured to maintain a same electromagnetic force intensity with a same polarity as the polarity of the cargo coupler head portion.

15. The joint structure of a vehicle body of claim 6, wherein, in a state where the vehicle is traveling on a sloped surface, each of the drive coupler body portions and the cargo coupler body portion are configured to change to form a same angle as the sloped surface while being coupled.

16. The joint structure of a vehicle body of claim 15, wherein, in a state where the vehicle is traveling on a sloped surface, each of the drive coupler head portions are configured to rotate by an angle so that an end portion of each of the drive coupler head portions engages with a boundary portion between the cargo coupler head portion and the cargo coupler body portion.

17. The joint structure of a vehicle body of claim 16, wherein the angle is between 13° and 15°.

18. The joint structure of a vehicle body of claim 17, wherein the cargo coupler head portion is configured to rotate within a range of 5° in a vertical direction at the boundary portion with the cargo coupler body portion.

19. The joint structure of a vehicle body of claim 4, wherein a stopper is positioned below the toothed gear and configured to stop rotation of the toothed gear to maintain a coupled state of the drive coupler and the cargo coupler.

20. The joint structure of a vehicle body of claim 19, wherein the stopper comprises:
a ratchet engaged with the toothed gear configured to stop rotation of the toothed gear;
an actuator connected to the ratchet and configured to linearly move the ratchet when power is supplied; and
a spring interposed between the ratchet and the actuator, and having elasticity to move the ratchet toward the toothed gear when power is not supplied to the actuator.
